(19) United States
(12) Patent Application Publication
(10) Pub. No.: US 2012/0148175 A1
(43) Pub. Date: Jun. 14, 2012

(54) HIGH-PRESSURE-TIGHT SLIDE BEARING DEVICE FOR MINIMALLY-INVASIVE INSTRUMENTS

(75) Inventor: Matthias Wesselmann, Ruedlingen (CH)

(73) Assignee: BIOTRONIK AG, Buelach (CH)

(21) Appl. No.: 13/306,518

(22) Filed: Nov. 29, 2011

Related U.S. Application Data
(60) Provisional application No. 61/420,802, filed on Dec. 8, 2010.

(51) Int. Cl. F16C 29/02

(52) U.S. Cl. 384/15

(57) ABSTRACT

A high-pressure-tight slide bearing device for minimally-invasive instruments comprises an inner shaft part (2), an outer part (3) which is seated thereon and is displaceable relative thereto, and a slippable seal (5) in a gap (4) between shaft part and outer part (2, 3), wherein the seal (5) consists of swellable, hydrophilic material which can be activated by the influence of a fluid in such a manner that due to the activation, the gap (4) is pressure-tight closed while, at the same time, sliding properties between shaft part and outer part (2, 3) are provided.

### CROSS REFERENCE TO RELATED APPLICATIONS

This invention claims benefit of priority to U.S. patent application Ser. No. 61/420,802 filed on Dec. 8, 2010; the content of which is herein incorporated by reference in its entirety.

### TECHNICAL FIELD

The invention relates to a high-pressure-tight slide bearing device for minimally-invasive instruments, the device comprising an inner shaft part, an outer part which is seated thereon and which is displaceable relative thereto, and a slippable seal in a gap between shaft part and outer part.

### BACKGROUND

As an example for such slide bearing devices for minimally-invasive instruments, sealed sliding connections between an inner shaft of a balloon catheter and the neck of a balloon seated on the outside thereof, for example for delivering a stent, or between an outer shaft and an inner shaft movable relative to the latter in case of so-called rolling membrane catheters are to be mentioned.

The documents WO 95/11055 A1 and US 2003/0212447 A1 which correspond with respect to their disclosure content to the present invention disclose a slippable seal—herein referred to for short as “slip seal”—which is formed between slipping sleeves and the catheter on which they are seated. The slip seal is formed here as tolerance fit between the inner diameter of the slipping sleeve and the outer diameter of the catheter shaft. In said documents, problems when retracting the slipping sleeves using a high pressure are described. In this case, the pressure can increase high enough that the seal opens and pressure fluid can escape between the inner diameter of the slip seal and the outer diameter of the catheter shaft. To solve this problem, the documents propose to glue an additional sealing member to the inner diameter of the slipping sleeves, which sealing member extends along the sleeve and underneath the same. This sealing arrangement is thus designated as “L-seal”. In case of a pressure increase, the L-seal is pressed closer against the outer diameter of the catheter whereby the risk of fluid leakage is reduced. Any measures to increase the sliding ability of the seal for a smooth movement of the sleeves can not be found in this document. As material for the slipping sleeves, only hydrophilic polymers are mentioned which have good sliding properties.

U.S. Pat. No. 6,238,410 B1 shows a catheter arrangement in which a sealed chamber is formed between an inner and an outer wall of a retractable sheath at the distal end of a catheter. Said sheath serves, for example, for enveloping a stent which is to be delivered to the region of a stenosis in a heart vessel. By retracting the sheath, the stent is released at the desired position in the vessel. The aforementioned document discloses a coating or filling of the sealed chamber with a lubricious substance to reduce the friction between the inner and outer wall of the sheath when retracting the same and without a contact taking place between the lubricious substance and a body fluid. Suitable lubricants are, for example, silicones, PVP and PPO. A sealing is not relevant for the catheter arrangement known from U.S. Pat. No. 6,238,410 B1 because the chamber has no fluid contact with a pressure fluid which would be used for this catheter.

From U.S. Pat. No. 5,957,930 A, a catheter for delivering a stent with a shaft seal is known, which shaft seal is connected as sliding seal with the distal end of the outer shaft of the catheter and forms a sliding sealing against the inner shaft with further extends in the distal direction. The sliding seal is to be made from an ionomeric polyolefin copolymer. This material has no significant swelling properties to bridge large tolerances in the region of the seal.

In summary, the slide bearing devices on minimally-invasive instruments known from the prior art are disadvantageous to the effect that their slippable seals rely on tight tolerances between sliding surfaces to achieve a sufficient tightness. If the tolerance is too small, there is the risk that the sliding fit jams and therefore a movement of the parts which are displaceable relative to each is not possible anymore or only with difficulties. If the tolerance is too wide, there is the risk of a leakage in the region of the slippable seal. A further difficulty of the minimally-invasive instruments discussed here is that the involved sealing partners are often formed by plastics which are subjected to dimensional changes due to relaxation or sorption. Also, in case of such slide bearing devices according to the prior art, an expansion when loaded, for example by a high pressure in the catheter shaft, can be observed.

### SUMMARY

Based on the problems described of the prior art, the object underlying the invention is to provide a high-pressure-tight slide bearing device for minimally-invasive instruments in which the gaps to be sealed between the involved inner and outer parts of the slide bearing device are closed in a pressure-tight manner without special requirements regarding component tolerances, but, at the same time, the friction between the slide bearing partners is reduced.

This object is solved by forming the slippable seal from a swellable hydrophilic material which can be activated by the influence of a fluid in such a manner that by the activation, the gap is closed in a pressure-tight manner while, at the same, sliding properties between shaft and outer part are provided.

Advantageously, in case of the seal according to the invention, the swelling of the material provides for a reliable, pressure-tight closure of the gap to be sealed, wherein the low friction occurs with the activation of the seal preferably by water or a contrast agent.

Preferably, the seal consists essentially of a coating on inner and outer parts which is formed, for example, from a highly swellable hydrophilic material. This involves, e.g., a hydrogel on the basis of polyvinylpyrrolidone. Other hydrogels usable as coating can also be used if they swell enough to bridge the gap and provide good friction properties.

Preferred embodiments provide an application of the coating on the outer side of the inner shaft part or the inner side of the outer part. The respective variant is to be selected according to the conditions for the sealing. It is important to consider that for such uses where the jamming of the sliding seal involves particularly negative effects for the patient or high risks, a particularly thick coating is ensured in the longitudinal axial direction in the region providing the seal per se and that the sealing effect is ensured in the entire sliding region by the element sliding thereon. The latter can be produced with high dimensional precision. In this respect it is of advantage if the coating forms a sliding face on the inner shaft part for the relatively displaceable outer part with an axial length of the sliding face which is greater than the axial length of a sliding seal face formed on the outer part. Preferably, the length of the sliding face is more than twice as long as the axial length of the sliding seal face.

Preferred uses of the slide bearing device according to the invention relate to a sliding seal between an inner shaft and the neck of a dilatable balloon of a balloon catheter or, respectively, between the inner shaft and the outer shaft of a catheter, wherein the seal is formed by a coating in the region of the distal end of the outer shaft. Preferably, the coating is then seated on the outer side of the inner shaft of the slide bearing device.

### DESCRIPTION OF THE DRAWINGS

Further features, details and advantages of the invention arise from the following description of exemplary embodiments based on the enclosed drawings. In the figures:

FIGS. 1 and 2 show schematic longitudinal axial sections of a slide bearing device with an inner shaft and a balloon before and after the elongation of the balloon,

FIGS. 3 and 4 show schematic longitudinal axial sections analog to FIGS. 1 and 2 in a second embodiment of the slide bearing device, and

FIGS. 5 and 6 show schematic longitudinal axial sections of a slide bearing device with an inner and outer shaft of a catheter in two different relative positions of inner to outer shaft.

### DETAILED DESCRIPTION

The slide bearing devices 1 shown in the figures serve for the use with minimally-invasive instruments. They have in common an inner shaft part 2 and an outer part 3 which is seated thereon and is displaceable relative thereto. In the gap 4 between the components, a slippable seal 5 is seated which consists of a highly swellable, hydrophilic material. As is yet to be illustrated in more detail, said material is activated by the influence of a fluid and thus swells. Thereby, the gap 4 between the inner shaft part 2 and the outer shaft part 3 is sealed in a high-pressure-tight manner. At the same time, good sliding properties are achieved between the inner shaft part 2 and outer part 3 due to the hydrophilicity of the material of the seal 5.

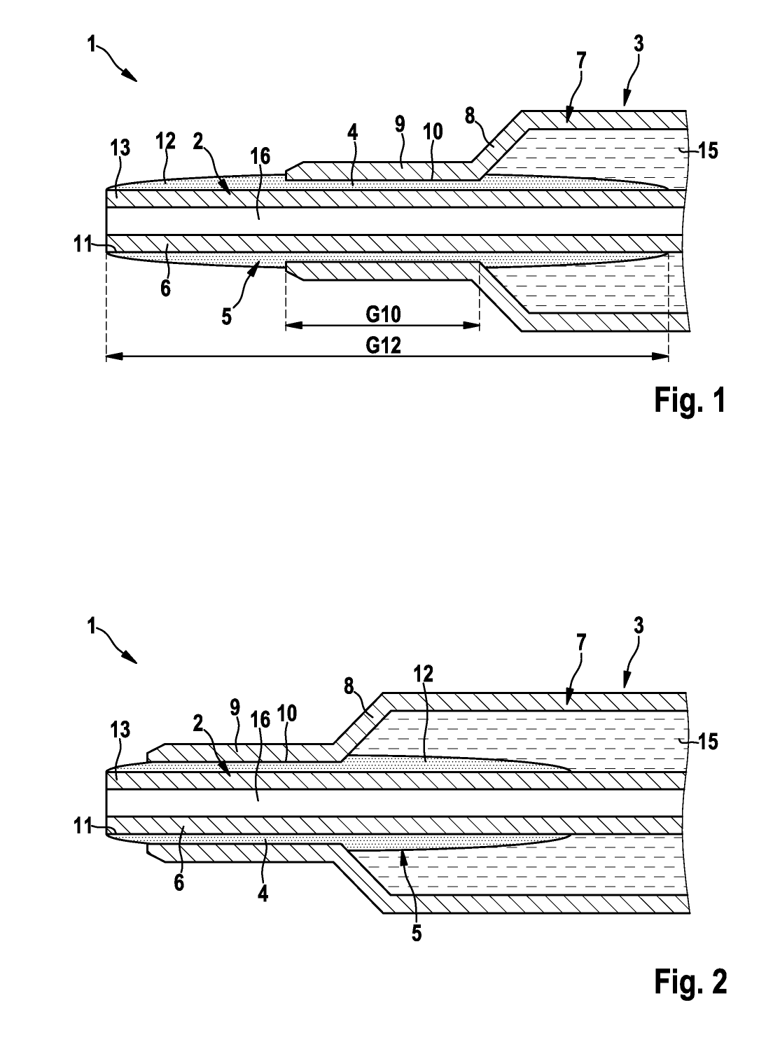

In the exemplary embodiment shown in the FIGS. 1 and 2, the inner shaft part 2 is formed by the inner shaft 6 of a minimally-invasive instrument in the form of a balloon catheter. In these drawings, the dilatable balloon 7 is illustrated as outer part which is displaceable relative to the inner shaft 6. Through a taper 8, the balloon 7 merges into the distal balloon neck 9, the cylinder casing-shaped inner side of which forms a sliding seal face 10 towards the inner shaft 6. The seal 5 itself is formed by a coating 12 applied by a hydrogel onto the outer side 11 of the inner shaft 6, wherein the coating extends over an axial sliding length G12 from the distal end 13 of the inner shaft in the proximal direction. The sliding length G12 of the coating 12 is significantly longer with respect to the length G10 of the sliding seal face 10 at the balloon neck 9, namely preferably more than twice as long.

As the comparison of the FIGS. 1 and 2 shows, thus, an advantageous floating connection of the distal end of the balloon 7 in the form of its balloon neck 9 to the inner shaft 6 is possible. This is particularly advantageous when using the shown subject matter of the invention with long angioplasty balloons with different pressure behavior—the so-called “compliance”—of balloon and inner shaft. A different plastic linear expansion of shaft and balloon under pressure can cause problems in case of fixedly connected balloons. Thus, in case of an excessive linear expansion of the balloon with respect to the inner shaft, transverse folds of the balloon are to be expected after deflating and therefore increased retracting forces when removing the catheter. If, after inflating and deflating the balloon, the inner shaft is too long in comparison to the balloon, the used guide wire can not be inserted a second time after removal because the inner shaft gets first compressed when reinserting the wire and finally buckles.

In both cases, the floating connection of the balloon end is helpful as the comparison of FIGS. 1 and 2 shows. Thus, prior to the state shown in FIG. 1, the coating 12 is activated by the influence of pressure fluid introduced into the balloon 7, that is, the previously relatively thin coating 12 swells considerably to form the configuration shown in FIG. 1 and provides a high-pressure-tight seal in the gap 4 between balloon neck 9 and inner shaft 6. Said seal was successfully tested at a pressure up to 30 bar during the development work for this invention. The balloon or the seal did not fail in any case. The maximum pressure to which such a seal is resistant can easily be increased by adapting the length of the seal. Due to the hydrophilicity of the seal material, the balloon neck 9 is still smoothly displaceable on the coating 12 and can be displaced in case of an elongation towards the distal end 12 on the coating 12 by the length AL. In this manner, transverse folds or buckling of the inner shaft 6 in case of different expansions of balloon 7 and inner shaft 6 are prevented. The inner shaft 6 is stress-free without the need that the materials of the balloon 7 and the inner shaft 6 have to be adapted to each other with respect to their compliance.

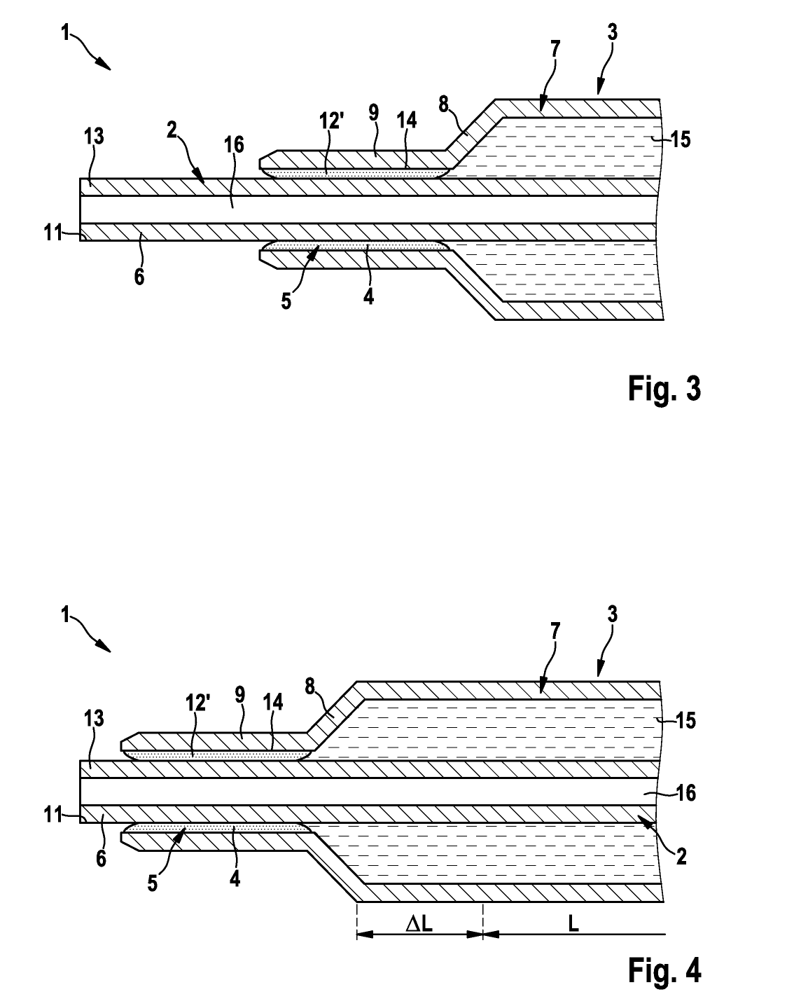

The embodiment of a slide bearing device shown in the FIGS. 3 and 4 is applied again between the inner shaft 6 and the balloon neck 9 of a balloon 7. In contrast to the embodiment according to the FIGS. 1 and 2, here, the material corresponding to the coating 12′ is applied on the inner side 14 of the balloon neck 9. The sealing is carried out in the same manner as it has already been described by means of FIGS. 1 and 2. During the elongation of the balloon by the dimension ΔL of its length L after the swelling of the coating 12′, again by activation by means of the pressure fluid 15, a uniformly low friction occurs during the sliding of the balloon neck 9 on the inner shaft 6.

By means of the design shown in the FIGS. 3 and 4 it is also possible to implement a catheter without inner shaft 6. Conventionally, in the lumen 16 in the inner shaft 6, a guide wire (not shown) is positioned on which the catheter is then pushed along to its place of destination within the body vessel. In case of the further innovation, which is not illustrated here, the inner shaft 6 is in fact implemented by the guide wire itself, with the outer side of which the balloon neck 9 then carries out the sealing function via its coating 12′ and, at the same time, a smooth displaceability of both components relative to each other is ensured. The guide wire itself has to be fluid-tight and its outer diameter has to be adapted to the seal diameter of the catheter. Through this design, the profile of the minimally-invasive instrument can be further reduced with respect to the cross-section, and/or the deflation times can be improved because the balloon lumen can be increased by the eliminated cross-section of the inner shaft.

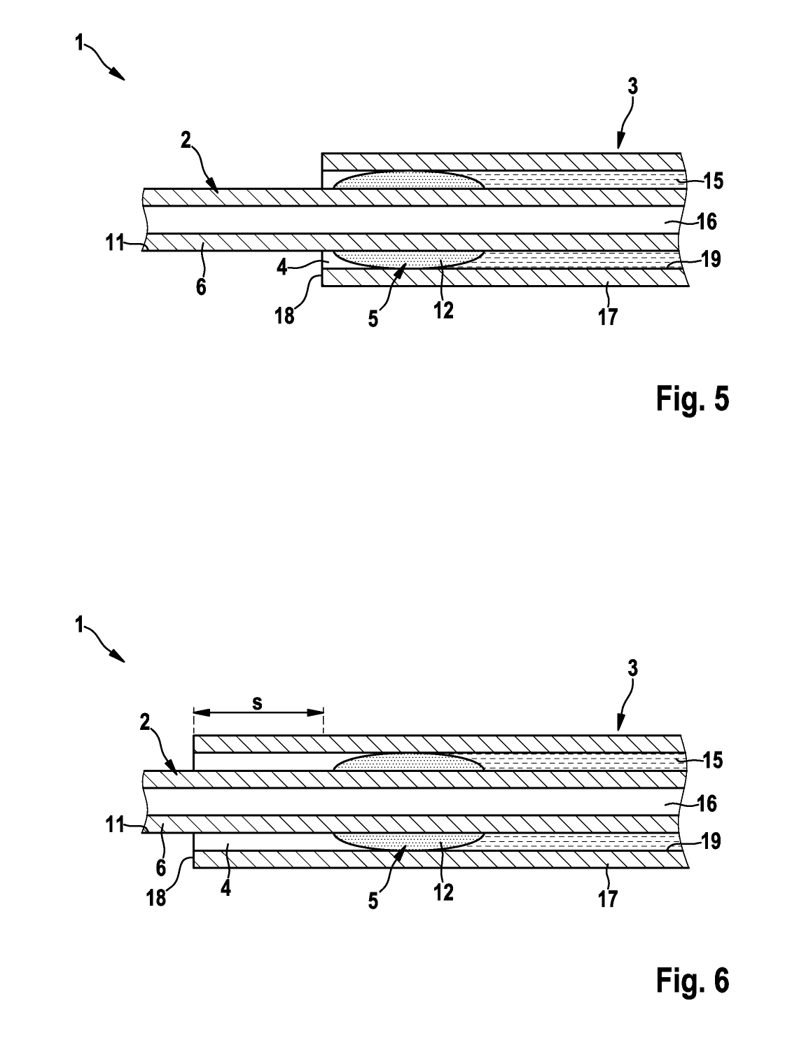

The version of a slide bearing device 1 illustrated in the FIGS. 5 and 6 is in particular intended for the use with so-called rolling membrane catheters where the inner shaft 6 has to be moved relative to an outer shaft 17. In the shown case, the slide bearing device 1 itself is formed by a coating 12 on the outer side 11 of the inner shaft 6, wherein in the starting position of the arrangement shown in FIG. 5, the coating is seated before the distal end 18 of the outer shaft 17. The coating 12 is formed again from the material mentioned in connection with the FIGS. 1 and 2. Through activation by means of the pressure fluid 15, the coating swells and generates a high-pressure-tight sealing to the inner side 19 of the outer shaft 17 and, at the same time, a slide bearing between inner shaft 6 and outer shaft 17. Due to said sealed slide bearing, the inner shaft 6 can be smoothly displaced relative to the outer shaft 17. The displacement length s drawn in FIG. 6 serves, for example, for controlling the rolling membrane of a rolling membrane catheter.

In summary, by the subject matter of the invention, a slide bearing device for minimally-invasive instruments is provided which can be produced in a simple manner and which is high-pressure-tight. The sliding function is only activated when the hydrophilic seal material is wetted by water or a contrast agent. In this manner, components of minimally-invasive instruments can be fixed and can be made movable at a predetermined point in time.

It will be apparent to those skilled in the art that numerous modifications and variations of the described examples and embodiments are possible in light of the above teaching. The disclosed examples and embodiments are presented for purposes of illustration only. Therefore, it is the intent to cover all such modifications and alternate embodiments as may come within the true scope of this invention.

What is claimed is:

1. A high-pressure-tight slide bearing device for minimally-invasive instruments, comprising:
an inner shaft part,
an outer part which is seated thereon and is displaceable relative thereto, and
a slippable seal in a gap between the shaft part and the outer part, characterized in that
the seal consists essentially of swellable, hydrophilic material which can be activated by the influence of a fluid in such a manner that due to the activation, the gap is pressure-tight closed while, at the same time, sliding properties between the shaft part and the outer part are provided.

2. The slide bearing device according to claim 1, characterized in that the seal consists essentially of a material selected from the group consisting of a hydrogel, polyvinylpyrrolidone (PVP), hyaloronic acid, PEG, dextran, and a cross-linked sugar.

3. The slide bearing device according to claim 1, characterized in that the seal is formed by a coating.

4. The slide bearing device according to claim 3, characterized in that the coating is applied on the inner side of the outer part.

5. The slide bearing device according to claim 3, characterized in that the coating is applied on the outer side of the inner shaft part.

6. The slide bearing device according to claim 5, characterized in that the coating forms a sliding face on the inner shaft part for the relatively displaceable outer part, the sliding face having an axial length which is greater than the axial length of a sliding seal face formed on the outer part.

7. The slide bearing device according to claim 6, characterized in that the axial length of the sliding face is twice as long as the axial length of the sliding seal face.

8. The slide bearing device according to claim 1, characterized in that the fluid for activating the seal is formed by water or a contrast agent.

9. The slide bearing device according to claim 1, wherein the outer part is formed by a neck of a dilatable balloon of a balloon catheter, characterized in that the seal is applied as coating on the inner side of the balloon neck.

10. The slide bearing device according to claim 9, characterized in that the balloon neck is mounted in a floating manner via the seal on the inner shaft part.

11. The slide bearing device according to claim 1, wherein the inner shaft part is formed by an inner shaft and the outer part by an outer shaft of a catheter, characterized in that the seal is formed by a coating in the region of the distal end of the outer shaft.

12. The slide bearing device according to claim 11, characterized in that the coating is applied on the outer side of the inner shaft.
